(19) United States
(12) Patent Application Publication
(10) Pub. No.: US 2005/0097198 A1
(43) Pub. Date: May 5, 2005

(54) Printer monitoring system and method

(76) Inventors: Robert M. Getler, Lexington, KY (US); Steven B. Rogers, Lexington, KY (US); Charles M. Zearfoss JR., Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/682,245

(22) Filed: Oct. 8, 2003

(51) Int. Cl. G06F 15/173

(52) U.S. Cl. 709/223; 709/224

(57) ABSTRACT

A printer monitoring system includes a first network, a first computer connected to the first network, and a first non-networked printer, having associated first printer status information, in communication with the first computer via a first peripheral connection. First agent software, configured to obtain the first printer status information from the first non-networked printer, is installed on the first computer. A monitor computer is in communication with the first computer via the first network. Manager software, configured to obtain the first printer status information from the first agent software, is installed on the monitor computer. A database is configured to store the first printer status information. The first computer executes the first agent software to obtain the first printer status information from the first non-networked printer, and the first agent software forwards the first printer status information to the manager software for storage in the database.

### BACKGROUND OF THE INVENTION

1. Field of the Invention

The present invention relates to a system and method for monitoring printers, and, more particularly, to a system and method for monitoring and collecting usage, configuration, and status data for non-networked peripheral printers that are connected locally to networked computers.

2. Description of the Related Art

In the current era, business concerns, both large and small, government, commercial, and private, prodigiously employ computer systems and printers in the conduct of daily operations. The computer systems and printers are typically used for many business functions, including the creation of internal documents such as memos, presentations, various records, process and routing sheets, etc., as well as documents intended for external use, i.e., by customers, patients, clients, and such, including brochures, statements, pamphlets, and so on. The printers used by such concerns include networked printers, e.g., printers that are connected to local area networks, such as workgroup printers, as well as local non-networked printers, e.g., printers that are peripherally connected to an individual computer by a conventional connection system, such as a parallel connection or via a universal serial bus (USB). The networked printers are typically employed by multiple users, whereas the non-networked printers are generally used only for printing with the computer system to which they connected.

The growing use of printers in such business concerns has magnified the need to monitor the printers for usage, configuration, and status. For example, it is desirable to know how many pages are printed by a printer in a given period of time, so that an appropriate amount of paper may be kept on hand for use by the printer. Similarly, it is desirable to ascertain the status of a printer's toner or ink supply, so that the appropriate supply levels might be maintained. In addition, it is desirable to obtain other useful data, for example, device maintenance meter data, and configuration data, such as, firmware level, toner cartridge identification or serial number, and memory disk size. Various systems are available to monitor an organization's networked printers, for example, by communicating with the networked printer via the network to determine the printer page count or toner level. Some such systems may be used by the organization in order to maintain stock of printer supplies, while others may be employed as part of a total printer solution package offered by a printer service provider, such as a printer manufacturer, in which case the customer organization's printers are monitored by the manufacturer, and the customer is billed on a usage basis for each printer.

What is needed in the art is a system and method for monitoring non-networked printers for usage, configuration, and status, and for collecting data pertaining thereto.

### SUMMARY OF THE INVENTION

The present invention provides a system and method for monitoring the usage, configuration, and status of non-networked printers that are peripherally connected to network-connected computers, and for collecting the usage, configuration, and status information pertaining to such printers.

The invention, in one form thereof, relates to a printer monitoring system, including a first network, a first computer connected to the first network, and a first non-networked printer in communication with the first computer via a first peripheral connection, the first non-networked printer having associated therewith first printer status information. First agent software is installed on the first computer, the first agent being software configured to obtain the first printer status information from the first non-networked printer. A monitor computer is in communication with the first computer via the first network. Manager software is installed on the monitor computer, the manager software being configured to obtain the first printer status information from the first agent software. A database is configured to store the first printer status information. The first computer executes the first agent software to obtain the first printer status information from the first non-networked printer via the first peripheral connection, and the first agent software forwards via the first network the first printer status information to the manager software executing on the monitor computer for storage in the database.

The invention, in another form thereof, relates to a method for monitoring a printer. The method includes the steps of providing a first network; providing a first computer connected to the first network; providing a first non-networked printer in communication with the first computer via a first peripheral connection, the first non-networked printer having associated therewith first printer status information; installing first agent software on the first computer, the first agent software configured to obtain the first printer status information from the first non-networked printer; providing a monitor computer in communication with the first computer via the first network; installing manager software on the monitor computer, the manager software configured to obtain the first printer status information from the first agent software; providing a database configured to store the first printer status information; and executing on the first computer the first agent software to obtain the first printer status information from the first non-networked printer via the first peripheral connection, the first agent software forwarding via the first network the first printer status information to the manager software executing on the monitor computer, and the monitor computer executing the manager software to receive the first printer status information and store the first printer status information in the database.

An advantage of the present invention is the ability to monitor printers to obtain usage, configuration, and status information without requiring that the printers be connected to a network.

Another advantage is the ability to obtain usage, configuration, and status information to provide for management of, and usage billing for, a non-networked printer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a printer monitoring system that utilizes the present invention.

FIG. 2 is a flowchart depicting a method according to the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

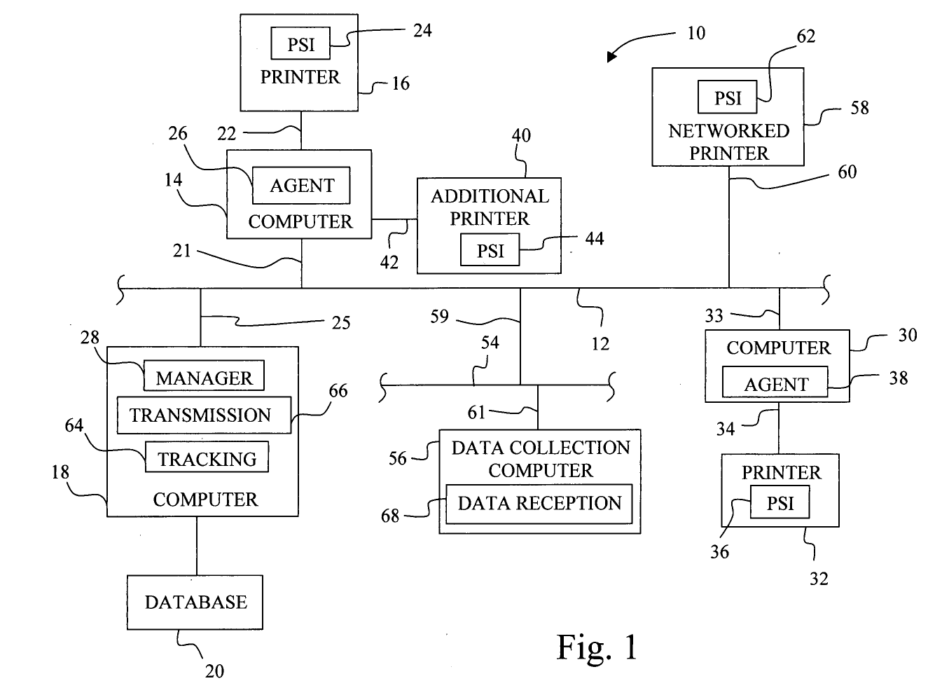

Referring now to the drawings and particularly to FIG. 1, there is shown a printer monitoring system 10 embodying the present invention. Printer monitoring system 10 is used in conjunction with a networked computer system, and includes a network 12, a computer 14 connected to network 12, a non-networked printer 16, a monitor computer 18, and a database 20.

Network 12 may be a conventional network, such as a local area network (LAN) or a wide area network (WAN) such as the Internet.

Computer 14 is a typical computer used in business or home applications, and may be, for example, a personal computer, including memory, an input device, such as a keyboard, and a display monitor. Computer 14 may further include a processor, input/output (I/O) interfaces, memory, such as RAM, ROM, NVRAM, a network adapter, a modem for dial-up connection, and at least one mass data storage device, such as a hard drive, a CD-ROM and/or a DVD unit. Computer 14 is connected to network 12 via a communication link 21, such as by a cable or wireless connection.

Non-networked printer 16 may be a printer used for business or home applications, and may be, for example, a laser printer, an inkjet printer, or an all-in-one unit that includes the ability to perform printing, scanning, copying, and faxing. In addition, non-networked printer 16 may be a copying machine, such as a digital copier, or any imaging apparatus capable of communication with computer 14, including any personal. or commercial machine capable of printing or reproducing printed material. Non-networked printer 16 is in communication with computer 14 via a peripheral connection 22. Peripheral connection 22 is a typical local connection, used for connecting non-networked printer 16 directly to computer 14, and may be, for example, a non-network connection such as a parallel connection, a USB connection, or a wireless connection.

Non-networked printer 16 has associated therewith printer status information (PSI) 24. Printer status information 24 is information that pertains to the usage, configuration, and status of non-networked printer 16, such as lifetime page count, toner level, printer serial number, printer jam status, printer operation records, device maintenance meter data, firmware level, toner cartridge identification or serial number, memory disk size, and any information generated by or stored in non-networked printer 16.

Monitor computer 18 is a typical computer, such as a workstation, personal computer, or a server. It is to be understood that the description of computer 14 applies equally to monitor computer 18. Monitor computer 18 is in communication with network 12 via a communication link 25, and is in communication with computer 14 via network 12. Communication link 25 may be, for example, a cable or wireless connection.

Database 20 resides on monitor computer 18. Alternatively, database 20 resides on another computer or device, such as external mass storage memory, and is accessible to monitor computer 18 via a direct or network connection. Database 20 is configured to store printer usage, configuration, and status information, such as printer status information 24.

Installed on computer 14 is agent software, such as agent software 26. Agent software 26 resides continuously on computer 14, i.e., is not mobile, and is in bi-directional communication with non-networked printer 16 via peripheral connection 22. Here, agent software 26 is configured to obtain printer status information 24 from non-networked printer 16, for example, by polling non-networked printer 16 on a periodic basis. Agent software 26 is also configured to obtain printer status information 24 on a demand basis, for example, by a user requesting agent software 26 to obtain status information via computer 14, or by agent software 26 on computer 14 receiving a command via network 12. In addition, agent 26 is configured to write printer status information 24 into a file, and store the file in a memory accessible by computer 14, for example, a disk drive associated with computer 14, or a networked drive accessible by computer 14.

Installed on monitor computer 18 is manager software 28. Manager software 28 is configured to obtain printer status information from agent software and store it in a database, for example, printer status information 24 may be received from agent software 26 for storage in database 20. Database 20 is a conventional database, such as any relational database. Alternatively, database 20 is a data file, such as a spreadsheet file, or any text-based file, such as a tab-delimited file or comma-delimited file.

Printer monitoring system 10 is configured so that computer 14 executes agent software 26 to obtain printer status information 24 from non-networked printer 16 via peripheral connection 22. Agent software 26 then forwards, via network 12, printer status information 24 to manager software 28 executing on monitor computer 18, for storage in database 20.

It is contemplated that printer monitoring system 10 may be employed to monitor more than one non-networked printer connected to more than one networked computer. Accordingly, printer monitoring system 10 may include another computer 30, and a non-networked printer 32.

Computer 30 is a typical computer, similar to computer 14. It is to be understood that the description of computer 14 applies equally to computer 30. Computer 30 is connected to network 12 via a communication link 33. Communication link 33 may be, for example, a cable or wireless connection.

Non-networked printer 32 may be similar to non-network printer 16. Non-networked printer 32 is in communication with computer 30 via a peripheral connection 34, and has associated therewith a printer status information 36. Peripheral connection 34 is a non-network connection, such as a parallel connection or a USB connection, or wireless connection, used for connecting non-networked printer 32 directly to computer 30. Printer status information 36 pertains to the usage, configuration, and status of non-networked printer 32, such as lifetime page count, toner level, printer serial number, printer jam status, printer operation records, device maintenance meter data, firmware level, toner cartridge identification or serial number, memory disk size, and any information generated by or stored in non-networked printer 32.

Installed on computer 30 is agent software, i.e., agent software 38, which is configured to obtain printer status information 36 from non-networked printer 32. Agent software 38 resides continuously on computer 30, and is in bi-directional communication with non-networked printer 32 via peripheral connection 34. The description of agent software 26 applies equally to agent software 38, but with respect to computer 30, non-networked printer 32, and printer status information 36.

Printer monitoring system 10 is configured so that computer 30 executes agent software 38 to obtain printer status information (PSI) 36 from non-networked printer 32 via peripheral connection 34, agent software forwarding, via network 12, printer status information 36 to manager software 28 executing on monitor computer 18 for storage in database 20. As such, database 20 may store printer status information for multiple printers.

It is also contemplated that printer monitoring system 10 may be employed to monitor more than one non-networked printer via an existing computer executing agent software. For example, where more than one non-networked printer is connected to a given computer, e.g., computer 14, the agent software is configured to receive corresponding printer status information from each non-networked printer directly connected to the computer. Accordingly, for example, printer monitoring system 10 may include at least one additional non-networked printer 40, each such non-networked printer being in communication with computer 14 via a corresponding peripheral connection 42. Each non-networked printer 40 has associated therewith a corresponding printer status information (PSI) 44. Agent software 26 is thus also configured to obtain the corresponding printer status information 44 from the additional non-networked printer 40 via corresponding peripheral connection 42.

With the additional non-networked printers, printer monitoring system 10 is configured so that, during operation, agent software 26 forwards, via network 12, the corresponding printer status information 44 to manager software 28 executing on monitor computer 18. Manager software 28 is configured to receive corresponding printer status information 44 from agent software 26, and store the corresponding printer status information 44 in database 20.

It is further contemplated that printer monitoring system 10 may be used in conjunction with an existing networked printer monitoring system, so that the status of all of an organization's printers may be monitored, such as non-networked printer 16, non-networked printer 32, and non-networked printer 40, as well as the organization's networked printers. As such, printer monitoring system 10 may also include a network 54, a data collection computer 56, and at least one networked printer 58.

Network 54 is a conventional network, such as a LAN, or a WAN, such as the Internet. Network 54 is connected to network 12 via a gateway 59. As shown, monitor computer 18 is connected to network 54 via network 12. Alternatively, monitor computer 18 may be connected directly to network 54, for example, via a dial-up connection.

Data collection computer 56 may be similar to computer 14, and accordingly the description of computer 14 applies equally to data collection computer 56. Data collection computer 56 is connected to network 54 via a communication link 61.

Networked printer 58 may be, for example, a printer used for business or home applications, as described with respect to non-networked printer 16. Alternatively, networked printer 58 may be a workgroup printer, copying machine, or any personal or commercial machine capable of printing or reproducing printed material. Networked printer 58 is connected to network 12 via a communication link 60, and has networked printer status information 62 associated therewith. Networked printer status information 62 is information that pertains to the usage, configuration, and status of networked printer 58, such as lifetime page count, toner level, printer serial number, printer jam status, printer operation records, and any information generated by or stored in networked printer 58.

Networked printer 58 is configured to forward networked printer status information 62 across network 12 via communication link 60 to monitor computer 18.

Installed on monitor computer 18 is tracking software 64 and transmission software 66. Tracking software 64 is configured to obtain networked printer status information 62 from networked printer 58 via network 12 and store the networked printer status information 62 on database 20. Transmission software 66 is configured, upon execution by monitor computer 18, to extract printer status information, such as printer status information 24, printer status information 36, corresponding printer status information 44, and networked printer status information 62, from database 20, and transmit the printer status information across network 54 to data collection computer 56.

Installed on data collection computer 56 is data reception software 68, which is configured to receive the printer status information via network 54, including printer status information 24, printer status information 36, corresponding printer status information 44, and networked printer status information 62, from monitor computer 18.

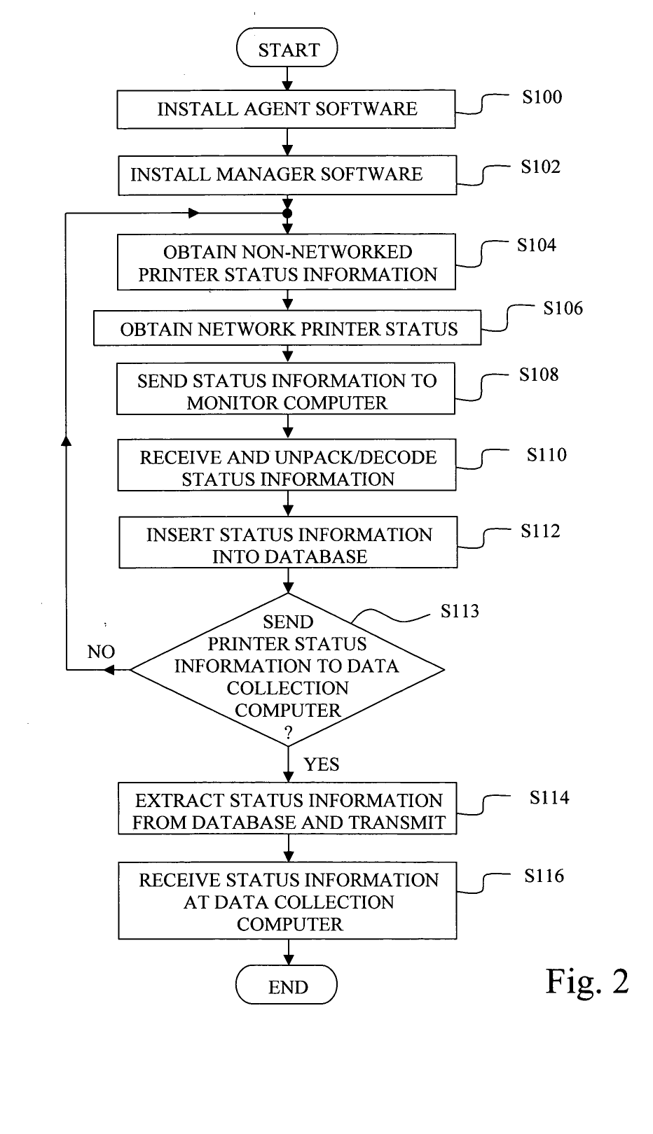

Referring now to FIG. 2, a method of monitoring printers in accordance with the present invention is now described.

At step S100, respective agent software is installed on each network connected computer that has at least one peripheral printer to be monitored, such as computer 14, and computer 30. Thus, agent software 26 is installed on computer 14, and agent software 38 is installed on computer 30. The agent software may be installed in a conventional manner, such as by loading the software from a floppy disc or CD-ROM, or downloading via network 12. As part of the installation, the agent software is configured to obtain corresponding usage, configuration, and status data for each associated non-networked printer. For example, agent software 26 retrieves printer status information 24 and printer status information 44, and agent software 38 retrieves printer status information 36. Alternatively, each agent software is preconfigured before installation, by the manufacturer or service provider of the agent software or the user, or is configured after installation by either manually or automatically downloading configuration data from a website hosted by the manufacturer or service provider of printer monitoring system 10.

At step S102, manager software 28 is installed on monitor computer 18 in a conventional manner, such as by loading the software from a floppy disc or CD-ROM, or downloading via network 12 the software from a manufacture's web site.

At step S104, the agent software obtains the non-networked printer status information from the non-networked printers. The printer status information is typically obtained by periodically polling the associated printer, e.g., every hour, or once per business day. The polling period may be set to any amount of time that is convenient, and may be unique to each instance of the agent software, i.e., unique to each of agent software 26, or agent software 38.

At step S106, monitor computer 18 executes tracking software 64 to obtain networked printer status information 62 from networked printer 58. As with the agent software, the networked printer status information 62 is obtained by periodically polling networked printer 58, with the polling period set as any convenient period of time.

At step S108, the agent software sends the non-networked printer status information and networked printer status information across network 12 to monitor computer 18. This printer status information may be sent, for example, in either encrypted or non-encrypted form. In addition, each instance of agent software writes the printer status information to a file, and stores the file in a memory accessible by the associated computer, such as a hard drive, or a networked drive accessible by the computer.

At step S110, manager software 28 executing on monitor computer 18 receives and unpacks/decodes the non-networked printer status information, including rendering it into a form suitable for storage in database 20.

At step S 112, manager software stores each piece of printer status information, such as printer status information 24, printer status information 36, printer status information 44, and printer status information 62, into database 20.

It is to be understood that steps S104 though SI 12 are repeated each time printer status information is obtained from each printer. For example, steps S104-S108 and S112 are performed each time agent software 26 obtains printer status information 24 from non-networked printer 16, and each time tracking software 64 obtains networked printer status information 62 from networked printer 58.

At step S113, a decision is made as to whether to send the printer status information to data collection computer 56. It is to be understood that printer status information may be sent to data collection computer 56 at any convenient time. For example, printer monitoring system 10 may be configured so that the printer status information is sent to data collection computer 56 daily or weekly, or each time printer status information is received by monitor computer 18.

At step S114, transmission software 66 extracts all of the printer status information from database 20 and transmits the printer status information across network 54 to data collection computer 56. The status information may be transmitted using any convenient format, such as SMTP or other email, hypertext transfer protocol (HTTP), or file transfer protocol (FTP).

At step S116, data collection computer 56 executes data reception software 68 to receive the printer status information via network 54. It is to be understood, however, that steps S104-S112 may be operating concurrently with steps S114 and/or S116.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A printer monitoring system, comprising:
a first network;
a first computer connected to said first network;
a first non-networked printer in communication with said first computer via a first peripheral connection, said first non-networked printer having associated therewith first printer status information;
first agent software installed on said first computer, said first agent software configured to obtain said first printer status information from said first non-networked printer;
a monitor computer in communication with said first computer via said first network;
manager software installed on said monitor computer, said manager software configured to obtain said first printer status information from said first agent software; and
a database configured to store said first printer status information,
said first computer executing said first agent software to obtain said first printer status information from said first non-networked printer via said first peripheral connection, said first agent software forwarding via said first network said first printer status information to said manager software executing on said monitor computer for storage in said database.

2. The printer monitoring system of claim 1, wherein said first agent software is in bi-directional communication with said first non-networked printer.

3. The printer monitoring system of claim 2, wherein said first agent software is configured to obtain said printer status information from said first non-networked printer on demand.

4. The printer monitoring system of claim 2, wherein said first agent software is configured to poll said first non-networked printer in order to obtain said first printer status information.

5. The printer monitoring system of claim 4, wherein said first agent software is configured to poll said first non-networked printer on a periodic basis.

6. The printer monitoring system of claim 1, wherein said first agent software is configured to receive corresponding printer status information from more than one non-networked printer directly connected to said first computer.

7. The printer monitoring system of claim 1, further comprising at least one additional non-networked printer, each said at least one non-networked printer being in communication with said first computer via a corresponding peripheral connection, each said at least one additional non-networked printer having associated therewith a corresponding printer status information, wherein said first agent software is configured to obtain said corresponding printer status information from said at least one additional non-networked printer via said corresponding peripheral connection, said first agent software forwarding via said first network said corresponding printer status information to said manager software executing on said monitor computer, and said manager software configured to receive said corresponding printer status information from said first agent software and store said corresponding printer status information in said database.

8. The printer monitoring system of claim 1, further comprising:
a second computer connected to said first network;
a second non-networked printer in communication with said second computer via a second peripheral connection, said second non-networked printer having associated therewith second printer status information;
second agent software installed on said second computer, said second agent software configured to obtain said second printer status information from said second non-networked printer,
said database configured to store said second printer status information, and
said second computer executing said second agent software to obtain said second printer status information from said second non-networked printer via said second peripheral connection, said second agent software forwarding via said first network said second printer status information to said manager software executing on said monitor computer for storage in said database.

9. The printer monitoring system of claim 1, wherein said first network is one of a local area network and the Internet.

10. The printer monitoring system of claim 1, further comprising:
a second network, said monitor computer connected to said second network;
transmission software installed on said monitor computer, said transmission software configured to extract said first printer status information from said database and transmit said first printer status information across said second network;
a data collection computer connected to said second network; and
data reception software installed on said data collection computer, said data reception software configured to receive said first printer status information,
said monitor computer executing said transmission software to extract said first printer status information from said database and transmit said first printer status information across said second network,
said data collection computer executing said data reception software to receive said first printer status information via said second network.

11. The printer monitoring system of claim 10, wherein said second network is one of a local area network and the Internet.

12. The printer monitoring system of claim 10, further comprising:
at least one networked printer connected to said first network, said at least one networked printer having at least one networked printer status information associated therewith and configured to forward said at least one networked printer status information across said first network;
tracking software installed on said monitor computer, said tracking software configured to obtain said at least one networked printer status information from said at least one networked printer via said first network and store said at least one networked printer status information on said database,
said monitor computer executing said transmission software to extract said at least one networked printer status information from said database and to transmit said at least one network printer status information across said network, and
said data collection computer executing said data reception software to receive said at least one networked printer status information via said second network.

13. A method for monitoring a printer, comprising the steps of:
installing first agent software on a first computer, said first agent software configured to obtain said first printer status information from a first non-networked printer in communication with said first computer via a first peripheral connection, said first non-networked printer having associated therewith first printer status information;
installing manager software on a monitor computer in communication with said first computer via a first network, said manager software configured to obtain said first printer status information from said first agent software;
executing on said first computer said first agent software to obtain said first printer status information from said first non-networked printer via said first peripheral connection, said first agent software forwarding via said first network said first printer status information to said manager software executing on said monitor computer; and
executing on said monitor computer said manager software to receive said first printer status information and store said first printer status information in a database configured to store said first printer status information.

14. The method of claim 13, wherein said first agent software is in bi-directional communication with said first non-networked printer.

15. The printer monitoring system of claim 14, said first agent software obtaining said printer status information from said first non-networked printer on demand.

16. The method of claim 14, said first agent software polling said first non-networked printer in order to obtain said first printer status information.

17. The method of claim 16, said first agent software polling said first non-networked printer on a periodic basis.

18. The method of claim 13, said first agent software receiving corresponding printer status information from more than one non-networked printer directly connected to said first computer.

19. The method of claim 13, further comprising the step of:
executing on said first computer said first agent software to obtain corresponding printer status information from at least one additional non-networked printer via a corresponding peripheral connection, said first agent software forwarding via said first network said corresponding printer status information to said manager software executing on said monitor computer, and said manager software receiving said corresponding printer status information and storing said corresponding printer status information in said database.

20. The method of claim 13, further comprising the steps of:
installing second agent software on a second computer connected to said first network, said second agent software configured to obtain second printer status information from said second non-networked printer;
executing on said second computer said second agent software to obtain said second printer status information from said second non-networked printer via said second peripheral connection;
said second agent software forwarding via said first network said second printer status information to said manager software executing on said monitor computer; and
said manager software receiving said second printer status information and storing said second printer status information in said database.

21. The method of claim 13, wherein said first network is one of a local area network and the Internet.

22. The method of claim 13, further comprising the steps of:
installing transmission software on said monitor computer connected to a second network, said transmission software configured to extract said first printer status information from said database and transmit said first printer status information across said second network;
installing data reception software on a data collection computer connected to said second network, said data reception software configured to receive said first printer status information;
executing on said monitor computer said transmission software to extract said first printer status information from said database and transmit said first printer status information across said second network; and
executing on said data collection computer said data reception software to receive said first printer status information via said second network.

23. The method of claim 22, wherein said second network is one of a local area network and the Internet.

24. The method of claim 22, further comprising the steps of:
providing at least one networked printer, said at least one networked printer having at least one networked printer status information associated therewith and configured to forward said at least one networked printer status information across said first network;
installing tracking software on said monitor computer, said tracking software configured to obtain at least one networked printer status information from at least one networked printer connected to said first network and configured to forward said at least one networked printer status information across said first network and store at least one networked printer status information associated with said at least one networked printer on said database,
executing on said monitor computer said transmission software to extract said at least one networked printer status information from said database and to transmit said at least one network printer status information across said network, and
executing on said data collection computer said data reception software to receive said at least one networked printer status information via said second network.

25. A method for monitoring a printer, comprising the steps of:
requesting via a first peripheral connection first printer status information associated with a first non-networked printer;
receiving via said first peripheral connection said first printer status information; and
transmitting via a first network said first printer status information to a monitor computer for storing in a database.

26. A method for monitoring a printer, comprising the steps of:
receiving at a first non-networked printer a request from a first computer for associated first printer status information via a first peripheral connection;
transmitting via said first peripheral connection said first printer status information to said first computer for transmission to a monitor computer via a first network for storage in a database configured to store said first printer status information.

27. A method for monitoring a printer, comprising the steps of:
receiving first printer status information associated with a first non-networked printer from a first computer via a first network, said first non-networked printer in communication with said first computer via a first peripheral connection; and
storing said first printer status information in a database configured to store said first printer status information.
